(19) United States
(12) Patent Application Publication
(10) Pub. No.: US 2003/0141049 A1
(43) Pub. Date: Jul. 31, 2003

(54) Load management auxiliary power system

(76) Inventor: Gino W. Kennedy, Jacksonville, FL (US)

Correspondence Address: MCHALE & SLAVIN, 4440 PGA BLVD, SUITE 402, PALM BEACH GARDENS, FL, 33410

(21) Appl. No.: 10/060,091

(22) Filed: Jan. 29, 2002

(51) Int. Cl. B60L 1/02; F02C 6/00; F02C 6/18; F01K 15/00; F01K 17/02; B60H 1/02; F24D 1/04; F24D 5/00; B60H 3/00; B61D 27/00; F02N 17/02; B60H 1/00; F25B 27/00; B60H 1/32

(52) U.S. Cl. 165/202; 165/42; 165/43; 62/236; 62/239; 62/244; 123/142.5 R; 290/2; 237/12.1

(57) ABSTRACT

An auxiliary power system for trucks, the power system having a small diesel engine coupled to an air conditioner compressor and an automotive style DC alternator. During hot weather the auxiliary engine rotates the air conditioner compressor to provide cool air to the truck accessories by load management controls alternator current output to provide DC power to accessories and for battery charging. When peak loads occur, the voltage is reduced into the field of the alternator in a form of load management wherein the truck batteries act as the power sink and the alternator is used to replenish any power drawn from the truck batteries when the peak demand is removed. During cold weather the engine coolant is used to cool the auxiliary engine and is circulated through a heat exchanger for warming of the truck interior, full capacity of the alternator is allowed accommodating the higher amp draws typical of cold weather diesel operation.

### FIELD OF THE INVENTION

This invention is related to auxiliary power systems and, in particular, to an auxiliary power system having an engine specifically sized to provide air conditioning, heating and an auxiliary DC power source for operating various accessories by use of load management.

### BACKGROUND OF THE INVENTION

Semi-truck tractor trailers frequently employ the use of an auxiliary generator to meet electrical requirements when the main engine is not running. Tractor trailers (“trucks”) having a “bunk” or “sleeper” cab area are common and most interstate fuel stations permit the drivers of such trucks to sleep in their cab area. The passenger area of the truck may include convenience items such as a television, VCR, refrigerator, air conditioner, coffee maker, even a microwave oven. While such items may run on direct current provided by an engine mounted alternator, or even alternating current by use of an inverter, the truck engine must be running to prevent a discharge of the batteries used for starting of the main diesel engine. Diesel engines are high compression and should the starting batteries be discharged, starting of the engine may not be possible.

New laws prohibit the idling of the main engine for prolong periods of time. However, the time and cost savings of keeping the driver near the truck while at rest are obvious and ancillary benefits include security as the operator does not leave the vehicle unattended. A problem with the use of auxiliary generators is directed to size, weight, and placement. The size of an auxiliary generator is critical for if the overall dimensions are too large, there will be insufficient areas on a truck for which to place the auxiliary generator.

The Applicant is a well known assembler of diesel engine/generators packages and has been awarded patents for various arrangements. U.S. Pat. Nos. 6,047,942 and 5,765,805 granted to the Applicant disclose the use of a combination engine/generator that is lightweight and of a novel space saving configuration, the contents of which are incorporated herein by reference.

The prior art also discloses numerous systems by which air conditioning and heating can be provided while the main engine is not running. Some systems, such as that disclosed in U.S. Pat. Nos. 4,756,359 and 4,762,170 utilize separate and wholly independent auxiliary air conditioning systems which are powered by auxiliary power plants.

U.S. Pat. No. 4,756,359 also discloses an auxiliary air conditioning, heating and engine warming system for trucks. This teachings of this patent employ an auxiliary power plant requiring a 2 cylinder, 12 Hp diesel engine. A chamber is used to receive hot exhaust gases from the auxiliary engine for purposes of heating the main truck engine. This patent does not teach the use of a load management to reduce the horsepower requirement of the engine or the need for engine efficiency necessary when a small engine is used for heating of the truck interior.

Trucks, RV's, and vessels that operate with generators typically include the use of an air conditioner that operates on 120 volts AC. The mounting of such an air conditioner may require placement on the roof or under the bunk of the vehicle which in many instances will void a manufacturers warranty.

Thus, what is needed is an auxiliary power system that is lightweight, consumes a small space, and may be used to provide heating, direct current power source and a means to provide air conditioning either after market or by attaching to an existing air conditioner to prevent voidance of structural warranties.

### SUMMARY OF THE INVENTION

The instant invention consists of a small diesel engine coupled to an air conditioner compressor and a DC alternator. In the preferred embodiment, a one cylinder Kubota diesel engine between 3 and 8 HP operates a standard automotive style air-conditioner compressor and a high output DC alternator. In operation, during hot weather the auxiliary engine operates to provide power to the air conditioner compressor and related air conditioner system components wherein the truck cabin is kept cool. The auxiliary engine further operates the alternator to provide DC power to the truck accessories and to replenish any power drawn from the truck batteries. When the air conditioner is activated, the alternator output is reduced by 50% limiting output draw. Should the truck accessories draw more than the alternator output during such a peak demand, the truck batteries operate as a reserve power source.

During cold weather, water used to cool the auxiliary engine is circulated through a heat exchanger. A fan is used to pass air through the heat exchanger to provide for warming of the truck interior. During cold weather, the full capacity of the alternator is available for the higher amp draws typical of cold weather where diesels engines are harder to start due to cold oil and cold batteries.

Thus, an objective of the invention is disclose an auxiliary power system for trucks that operates as a load management system without the need for conventional load shedding, sharing or management controls.

Another objective of the invention is to disclose an efficient auxiliary power system for trucks by providing air conditioning and heating to a truck interior with a diesel engine having less than eight horsepower.

Still another objective of the invention is disclose an auxiliary power system for trucks that provides both air conditioning, heating, and DC power utilizing existing batteries as a power sink for peak loads.

Still another objective of the invention is disclose an auxiliary power system for trucks that can be used to operate existing underbunk air conditioners and heaters.

Another objective of the invention is disclose an auxiliary power system for trucks that captures heat from the engine coolant for warming of the truck interior.

Yet another objective of the invention is to disclose the use of an auxiliary power system that is inexpensive, small in size and light in weight.

Yet still another objective of the invention is to disclose the use of the 4 HP KUBOTA EL 300 AR as a preferred engine having a single cylinder horizontal design that eliminates the counter balance thereby allowing additional oil capacity for longer periods between oil changes, and provides for very quiet operation.

Other objectives and advantages of this invention will become apparent from the following description taken in conjunction with the accompanying drawings wherein are set forth, by way of illustration and example, certain embodiments of this invention.

### BRIEF DESCRIPTION OF THE DRAWINGS

FIG. 1 is a diagrammatic representation of an auxiliary power unit system;

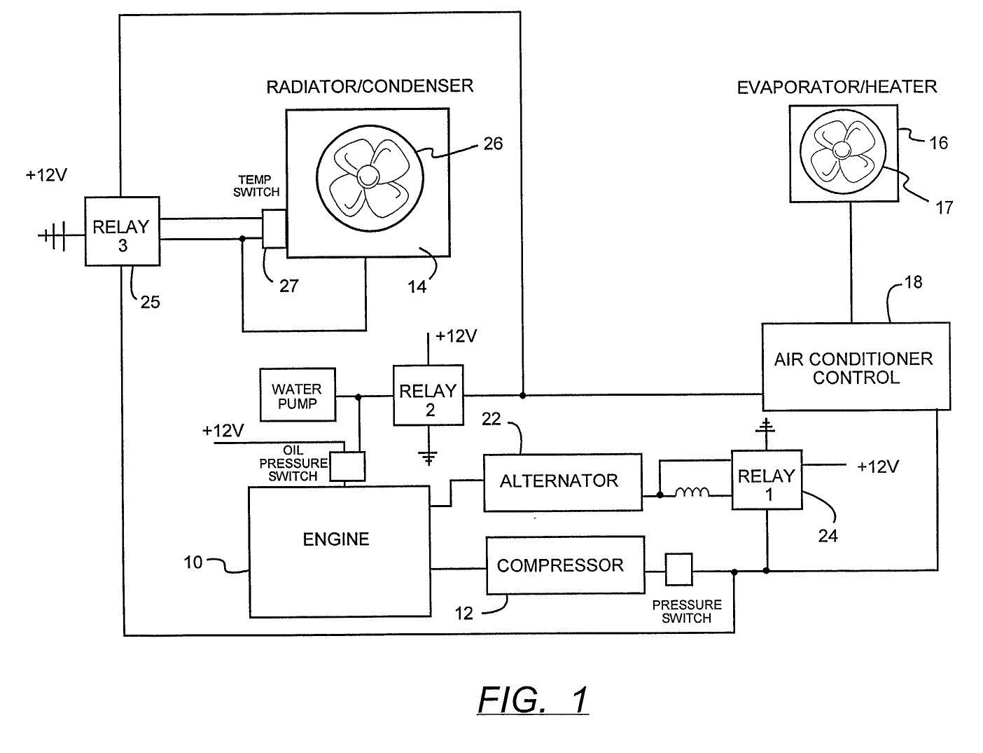

FIG. 2 is a further diagrammatic representation of FIG. 1 illustrating placements of an air conditioner, heater unit, and power inverter; and

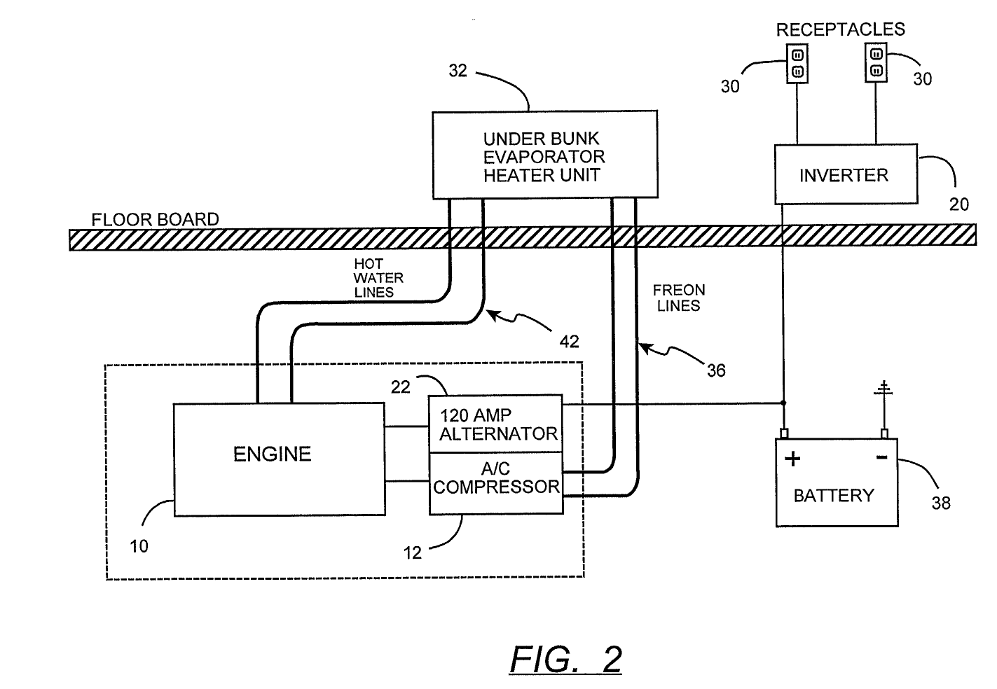

FIG. 3 is a diagrammatic representation of engine coolant circulation system.

### DETAILED DESCRIPTION

Now referring in general to the Figures, the auxiliary power unit of the instant invention consists of a small diesel engine 10 coupled to an air conditioner compressor and a DC alternator. The air conditioning system is conventional and consists of a compressor 12, condenser/radiator fan 26, condenser 14, evaporator 16, evaporator/heater fan 16, and an air conditioner controller 18. As will be explained later in this specification, the auxiliary power unit may be adapted to an existing air conditioning system or the air conditioning system may consist of an add-on air conditioning system such as that found in a sleeper bunk compartment. A high output automotive style alternator 22 is coupled to the engine 10 providing direct current to various air conditioner support components and other DC accessories as well as batteries.

In a preferred embodiment, a one cylinder horizontal Kubota EL 300 AR engine capable of producing 4 HP is coupled to a 12,000 BTU air conditioner compressor and a high output alternator of about 120 amps on a 12 volt system. Under this arrangement, load management occurs by limiting or reducing of the output current of the alternator by approximately 50% when the compressor engages. For instance, when the air conditioner is running, operation of the support components such as the evaporator/heater fan will draw approximately ten amps, operation of the condenser/radiator will draw approximately ten amps, operation of the fuel pump, water pump, and engine solenoids will draw approximately five amps, and so forth totaling approximately 30 amps on a 12 volt system.

Thus, a high output alternator, even with load management will provide a positive supply of current. The power produced by the alternator is available for operating accessories such as an AC inverter 20 allowing the operation of household appliances 30 such as razors, coffee makers, microwave ovens, alarm clocks, VCR's and so forth. Further, parking lights, television, CB radio, stereos, refrigerator, interior lights and the like devices, not shown, are all commonly used and require power for operation. Should the power requirements be exceeded, due to peak draw devices such as a microwave oven or coffee maker, the existing truck batteries 38 will produce the necessary power by operating as a power sink as the compressor clutches in and out wherein the alternator shifts between full load and half load. Once the peak load is removed, the alternator will replenish the batteries 38 so that the necessary power is available for the primary purpose of starting the main diesel engine that has been turned off. The condenser 18 may accompany, or be integrated with the auxiliary engine radiator, so that a single cooling fan 26 could be used. Alternatively, the auxiliary engine may circulate coolant through the existing truck radiator although heater efficiency may not be optimized.

The condenser and heat exchanger assembly 32 may be located underbunk wherein Freon lines 36 are run from the auxiliary engine mounted compressor as well as water lines 34 from the engine block for circulation through the heat exchanger 32. The alternator 22 may be based on 12 volts, 24 volts or voltage dependant upon the trucks electrical system. Unique to this application is that the higher current demands occur in cooler weather when air conditioning demands are low.

Upon start up, the engine oil pressure is checked and if sufficient voltage is supplied to the air conditioning control 18 by relay 2 and to the temperature switch 27, at this time the radiator/condenser fan 26 engages at the temperature set point of the temperature switch 27.

In warm weather the air conditioning demands are high but the DC demands are reduced. When the air conditioner controls are turned to cold, relay 24 is engaged for limiting alternator 22 output. A compressor clutch is engaged as long as an air conditioner pressure switch is closed, thereby the compressor will cycle on and off as required due to thermostat setting. Relay 25 is engaged bypassing temperature switch 27 so that the radiator/condenser 26 runs continually providing air for the condenser 14. It is noted that the relays used in the invention can be substituted with chips or any other switching device, the variations of which are incorporated herein.

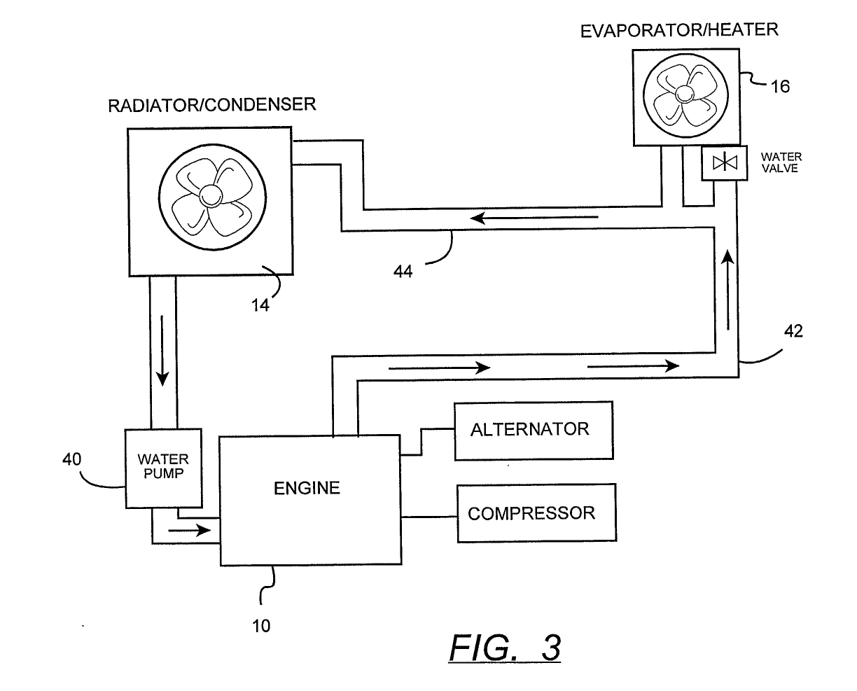

During cold weather, the water used to cool the auxiliary engine 10 is circulated through the evaporator/heater 16 by opening of a water valve which allows hot engine coolant to pass through a heater core. The evaporator/heater fan 17 is turned on and used to draw air through the heater core for use in warming of the truck interior. The radiator/condenser fan 26 cycles as required by the temperature switch 27 to regulate the engine temperature variations. It should be noted that by operating of an engine at its optimum rpm's and approximately 80% of full load draw, the engine is operated at its most fuel efficient level and provides a fast and reliable heat source from the engine coolant. A further benefit of not operating an air conditioner during the cooler weather is that the additional amperage draw used to operate the air conditioning support components is not needed whereby the maximum alternator output is available to power the parking lights, television, CB radio, refrigerator, AC inverter, interior lights and so forth but accommodate the higher battery replenishment requirements necessary in cold weather operation. In this condition, the alternator gives full output. As shown in FIG. 3, the engine coolant is circulated through the engine 10 by an electric water pump 40. The engine coolant is fluidly coupled 42 to a heater core located in the evaporator/heater assembly 16 with an outlet 44 coupled to the radiator assembly 14 which is then circulated back to the engine 10 by the water pump 40.

In an alternative embodiment, a Kubota EA 300 NB engine capable of producing 7 HP may be coupled to, or rotate an air conditioner compressor at a higher rate, so as to produce 16,000 BTU or higher levels as well as to the high output alternator. The larger engine provides a faster cool down of the truck interior but, as evident by the previous discussion the additional horsepower, may not benefit the efficiency of the system and may decrease the efficiency of the system during the cooler weather. Thus, the teaching herein is toward smaller, lighter, and less expensive diesel engines by relying upon load or horsepower management.

For purposes of simplification, this application has been directed to trucks although it would be obvious to one of ordinary skill in the art to recognize that the teachings of this patent and the associated claims may be directed to buses, boats, ambulances and so forth. Further, alternator changes to address higher voltage systems are to be substituted throughout this specification and considered an obvious variation within the scope of the patent. It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What I claim is:

1. An auxiliary power unit system for use in combination with existing batteries in trucks having an interior compartment, said system comprising:
a water cooled diesel engine positioned outside said compartment, said engine capable of producing not more than 8 horsepower;
a heat exchanger fluidly coupled to said engine, said water circulated between said engine and said heat exchanger by a water pump;
an air conditioner system having a compressor, an evaporator and a condenser, said compressor coupled to said engine; and
an alternator coupled to said engine;
wherein operation of said auxiliary power unit system in cold weather allows said heat exchanger to provide warm air for distribution within said interior compartment, said air conditioner provides cool air for distribution within said interior compartment, whereby any peak power demands that exceed said alternator output are supplied by said truck batteries.

2. The auxiliary power unit according to claim 1 wherein said condenser and said radiator share a heat dispensing fan.

3. The auxiliary power unit according to claim 1 including a means for managing amperage output of said alternator other than the change due to charging.

4. The auxiliary power unit according to claim 3 wherein said means for managing said alternator includes reduction of output amperage by about 50 percent.

5. The auxiliary power unit according to claim 1 wherein said alternator provides power for operation of conventional direct current accessories.

6. The auxiliary power unit according to claim 1 wherein said air conditioner is about 12,000 BTU and said engine is about 4 horsepower.

7. The auxiliary power unit according to claim 5 wherein said engine is a 4 HP KUBOTA EL 300 AR.

8. The auxiliary power unit according to claim 1 wherein said air conditioner is about 16,000 BTU and said engine is about 7 horsepower.

9. The auxiliary power unit according to claim 8 wherein said engine is a 7 HP KUBOTA EA 300 NB.

10. The auxiliary power unit according to claim 1 including an inverter to provide AC power.

11. The auxiliary power unit according to claim 1 wherein said air conditioner is about 12,000 BTU, said engine is about 7 horsepower, and said alternator has an output about 80 amps at 12 volts DC.

12. An auxiliary power unit system for use in combination with existing batteries in trucks having an interior compartment, said system comprising:
a water cooled diesel engine positioned outside said compartment, said engine capable of producing about 4 horsepower;
a heater fluidly coupled to said engine, said water circulated between said engine and said heat exchanger by a water pump;
an air conditioner system producing about 12,000 BTU having a compressor, an evaporator and a condenser, said compressor coupled to said engine; and
an alternator coupled to said engine capable of generating about 120 amperes 12 volts DC;
wherein operation of said auxiliary power unit system in cold weather allows said heat exchanger to provide warm air for distribution within said interior compartment and in warm weather said air conditioner provides cool air for distribution within said interior compartment whereby any auxiliary power demands are provided by said alternator and those demands that exceed said alternator current are supplied by said truck batteries.

13. The auxiliary power unit according to claim 12 wherein said condenser and said radiator share a heat dispensing fan.

14. The auxiliary power unit according to claim 12 including a means for altering the output current of said alternator other than the change due to charging.

15. The auxiliary power unit according to claim 12 wherein said alternator provides direct current for operation of conventional items.

16. The auxiliary power unit according to claim 12 wherein said engine is a 4 HP KUBOTA EL 300 AR.
